(19) United States
(12) Patent Application Publication
(10) Pub. No.: US 2008/0168699 A1
(43) Pub. Date: Jul. 17, 2008

(54) Fishing Rod Having A Single Main Tube

(76) Inventors: Roberto Gazzara, Mestre (IT); Mauro Pinaffo, Camposampiero (IT); Mauro Pezzato, Treviso (IT); Michele Pozzobon, Fossalunga di Vedelago (IT); Stephen J. Davis, Newtown, PA (US)

Correspondence Address: FOX ROTHSCHILD, LLP, 625 LIBERTY AVENUE, PITTSBURGH, PA, 15222-3155, US

(21) Appl. No.: 11/971,005

(22) Filed: Jan. 8, 2008

Related U.S. Application Data
(60) Provisional application No. 60/879,421, filed on Jan. 8, 2007.

(51) Int. Cl. A01K 87/00; B29C 35/02; B29C 39/10

(52) U.S. Cl. 43/18.5; 43/18.1 R; 264/241

(57) ABSTRACT

A fishing rod has a single, hollow, primary tube, preferably of composite material, wherein one or more open ports extend through aligned holes on opposite sides of the hollow tube. The ends of the ports are bonded to the walls of the hollow tube. The ports improve the stiffness, strength, aerodynamics, and aesthetics of the fishing rod.

### RELATED APPLICATIONS

This application claims the benefit of U.S. Provisional Application Ser. No. 60/879,421, filed Jan. 8, 2007, entitled “Fishing Rod Having a Single Main Tube”.

### FIELD OF THE INVENTION

This invention is related to the field of sports equipment, and, in particular, to fishing rods composed of a composite material.

### BACKGROUND OF THE INVENTION

The performance of a fishing rod is determined by a number of factors such as weight, flex, flex distribution, torsional stiffness, and strength. The traditional fishing rod is a single solid structure or a tubular structure with a tapered circular cross section and a hollow interior. The wall thickness can vary along the length of the rod to provide specific performance characteristics. The modern fishing rod is made with light weight composite materials.

The weight of a fishing rod is one characteristic that is critical to the performance of the rod. The lighter the weight of the rod, the easier it is to swing the rod, resulting in longer casting distances. Therefore, the lightest materials and designs are typically used to achieve this performance goal. The most popular high performance material for modern fishing rod design is carbon fiber reinforced epoxy resin (CFE), because it has the highest strength and stiffness to weight ratio of any realistically affordable material. As a result, CFE can produce a very light weight fishing rod with excellent strength as well as allowing for variations in the stiffness of the rod.

The overall stiffness and the stiffness distribution of a fishing rod are also important factors in determining performance. Preferably, the bending stiffness of the fishing rod will match the forces created by the acceleration imposed by the casting motion to have the proper recovery such that the bait is delivered to the intended target.

There are numerous casting motions and directions. A cast typically varies from a vertical casting plane to a horizontal casting plane. These different casting motions will load the rod in directions perpendicular to each other. The vertical cast, or overhead cast, is capable of a higher acceleration and therefore imposes a higher load on the rod. The horizontal cast is a more controlled cast, and can be used, for example, for casting under tree limbs with limited motion. The horizontal cast would therefore benefit from a more flexible rod.

Carbon fiber composites offer very high stiffness to weight ratios, and, because of their anisotropic properties, can be tailored to provide different varied stiffness in different directions and at different locations along the length of the rod. However, there are limitations based on the traditional design of the single tube fishing rod.

There are also limitations on the strength of carbon fiber based fishing rod structures. The rod, during normal use, may be subjected to a multitude of stress conditions. The primary load on a typical rod is a bending load produced by casting or from the drag caused by the pull of a fish. Under such circumstances, excessive compressive forces may cause buckling of the thin walled tube, leading to catastrophic failures of the rod. There are also impact loads and vibrational loads to consider. In addition, there are high stress concentrations where the reel connects to the rod. The clamping mechanism to attach the reel to the rod can impose a large circumferential compressive stress on the rod in this area. Furthermore, the guides which guide the line can exert forces on the rod at their points of attachment. For this reason, the wall thickness of the rod is often greatest in these areas. As a result, the rod can be heavier than desired.

The evolution of the modern fishing rod has been focused on reducing weight and improving stiffness and strength. However, there has not been a fishing rod that has improved casting distance, or provided anisotropic behavior in different directions.

The traditional light weight composite fishing rod is made using sheets of fiber reinforced epoxy called “prepreg” wrapped around a steel mandrel and consolidated and cured using external heat and pressure. There have been numerous patents describing this construction, such as U.S. Pat. No. 2,749,643 (Scott), U.S. Pat. No. 3,421,347 (Hubbard) and U.S. Pat. No. 4,061,806 (Lindler, et. al). Other notable patents producing a single hollow tube constructions are U.S. Pat. No. 4,178,713 (Higuchi), U.S. Pat. No. 4,653,216 (Inoue), U.S. Pat. No. 6,454,691 (Hsu), U.S. Pat. No. 6,601,334 (Ono et. al) and U.S. Pat. No. 7,043,868 (Ahn).

Other notable designs involve having the line travel inside the rod, some of which involve an internal structure to facilitate this feature. Examples are U.S. Pat. No. 5,564,214 (Tsurufuji), U.S. Pat. Nos. 6,048,425 and 6,543,178 (Sunaga et. al), U.S. Pat. No. 6,243,981 (Komura et. al) and U.S. Pat. Nos. 6,266,913, 6,334,272, and 6,351,909 (Akiba, et. al).

There exists a continuing need for an improved fishing rod that has the combined features of improved aerodynamics, light weight, improved bending stiffness, and improved strength.

### SUMMARY OF THE INVENTION

The present invention is a fishing rod where at least a portion of the rod is formed of a single, hollow tube having at least one, and preferably a series, of ports that extend through the hollow tube. The ports provide specific performance advantages. Each port has a peripheral wall that extends between opposed, aligned holes in the hollow tube to form the port. The opposite ends of each port are bonded to the walls of the rod tube. The wall forming the port, which extends between opposite sides of the rod tube, is preferably elliptically-shaped to form opposing arches, which provide additional strength, stiffness, comfort, and aesthetic benefits. The ports provide an aerodynamic advantage because they allow air to pass through the ports during casting, which reduces the aerodynamic drag of the rod, resulting in higher casting speed and longer casts.

There are no known designs using ports, holes or apertures through the rod for performance benefits, primarily because cutting holes in the walls weakens the structure considerably when reinforcing fibers are severed during the cutting of the holes.

The present invention applies preferably to composite fishing rods, but will apply to tubular fishing rods of all materials. For the composite fishing rod, the holes to accommodate the ports may be formed in the primary tube prior to molding by punching or other suitable means. Although carbon fibers may be cut in the process, the primary tube retains strength due to the fact that, after molding, the tubular insert members which form the peripheral walls of the ports, are bonded to the hole edges and extend across the primary tube. Alternatively, the holes may be formed by separating fibers in the wall of the rod, in which case fibers will not be cut.

The present invention is designed to provide a combination of improved aerodynamics, light weight, tailored stiffness, improved strength, and improved aesthetics over current prior art rods.

The present invention provides a new and improved fishing rod of durable and reliable construction which may be easily and efficiently manufactured at low cost with regard to both materials and labor. The rod provides improved aerodynamics during casting, has superior strength and fatigue resistance, and provides a unique look and improved aesthetics. The improved rod also allows for specific stiffness zones at various orientations and locations along the length of the rod.

For a better understanding of the invention and its advantages, reference should be made to the accompanying drawings and descriptive matter in which there are illustrated preferred embodiments of the invention.

### BRIEF DESCRIPTION OF THE DRAWINGS

FIG. 1 is an isometric view of a fishing rod constructed in accordance with an embodiment of the present invention.

FIG. 2 is a front view of a portion of the rod of FIG. 1 showing the bladders in place.

FIG. 3 is a front view of a portion of the rod during a subsequent step in the manufacturing process showing the tubes forming the peripheral walls of the ports in place.

FIG. 4 is a cross-sectional view of the prepreg tube of FIG. 3, taken through lines 4-4.

FIG. 5 is a side view of the prepreg tube of the prepreg tube of FIG. 3 during a subsequent manufacturing step in showing the mold pins being inserted into the ports.

FIG. 6 is an isometric view of a portion of the rod after molding.

FIG. 7 is a longitudinal sectional view, taken through lines 7-7 of FIG. 6.

FIGS. 8a and 8b illustrate an alternative production method.

### DETAILED DESCRIPTION OF THE INVENTION

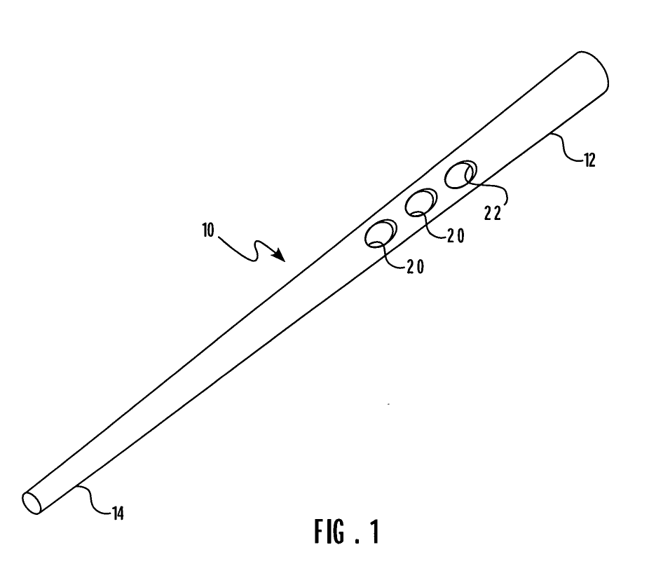

With reference to FIG. 1 of the drawings, the present invention is a composite fishing rod 10, featuring one or more ports formed into the walls of the rod for improving the flexibility, strength and other characteristics of the rod. Rod 10 comprises a handle end 12, about which a grip and reel are normally attached, and a tip end 14, to which a loop shaped line guide is typically attached. Rod 10 is preferably fabricated of multiple layers of aligned carbon filaments held together with an epoxy binder. The fibers in the various plies are preferably parallel to one another, but the various plies preferably have varying fiber orientations. Rod 10 has a long, generally hollow configuration that preferably tapers from the handle end 12 to the tip end 14.

A plurality of ports 20 are formed in rod 10, preferably near handle end 12. Ports 20 extend between opposed, aligned walls of the rod, as described in more detail below. Each port may be of any shape, but is preferably oval in shape, with the long axis of the oval in line with the longitudinal axis of rod 10. Each port 20 includes a peripheral wall 22 (see FIGS. 6-7) that extends, in one embodiment, between the front face and the rear face of the rod. The opposing ends of peripheral wall 22 are bonded to the tubular rod 10. As used herein, the “front” face of rod 10 refers to the surface where the line guides are mounted, in the direction of an overhead cast, while the “rear” face is the surface facing the user of the rod.

The ports are preferably in the shape of double opposing arches which allow the structure to deflect, which deforms the ports, and allows them to return with more resiliency. The ports also allow greater bending flexibility and strength than would traditionally be achieved in a single tube design because internal columns formed by the peripheral walls of the ports help prevent buckling failures of the thin walled tubular rod. If the axes of the ports are in line with the casting direction, they can also provide an aerodynamic advantage, allowing air to pass through the rod, resulting in faster swing speeds and further casts. Finally, the ports create a unique appearance to the fishing rod.

The fishing rod is preferably made from a fiber reinforced composite material. Traditional lightweight composite structures have been made by preparing an intermediate material, known as “prepreg”, which will be used to mold the final structure. Prepreg is formed by embedding fibers for, for example, carbon, fiberglass, and others, in resin. This is typically done using a prepreg machine, which applies the non-cured resin over the fibers so they are wetted out. The resin is at “B Stage” meaning that only heat and pressure are required to complete the cross linking and to harden and cure the resin. Thermoset resins, like epoxy, are popular because they are available in liquid form at room temperature, which facilitates the embedding process.

A thermoset is created by a chemical reaction of two components, forming a material in a nonreversible process. Usually, the two components are available in liquid form, and after mixing together, will remain as a liquid for a period of time before the cross-linking process begins. It is during this “B Stage” that the prepreg process happens, where the resin coats the fibers. Common thermoset materials are epoxy, polyester, vinyl, phenolic, polyimide, and others.

The prepreg sheets are cut and stacked according to a specific sequence, with particular attention given to the fiber orientation of each ply. Each prepreg layer comprises an epoxy resin combined with unidirectional parallel fibers from the class of fibers, including but not limited to carbon fibers, glass fibers, aramid fibers, and boron fibers. The prepreg is cut into strips at various angles and laid on a table. The strips are then stacked in an alternating fashion such that the fibers of each layer are oriented differently from the adjacent layers. For example, one layer may be +45 degrees, the next layer −45 degrees. If more bending stiffness is desired, a fiber angle such as zero degrees is used. If more torsional stiffness is desired, a higher proportion of +/−45 degree strips are used. If more bending stiffness is desired, a higher proportion of 0 degree fibers are used. Other fiber angles may also be used. Additionally, the stiffness may be varied in different places along the length of the rod using the method just discussed.

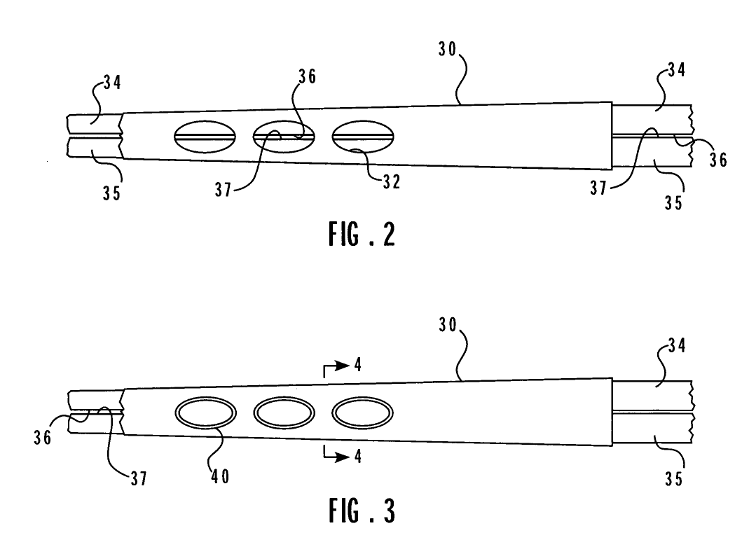

This lay-up, which comprises various strips of prepreg material, is then rolled over an internal mandrel in the shape of a tapered tube. Referring to FIG. 2, according to the preferred embodiment of the invention, a suitable uncured prepreg tube 30 is formed in the manner just described, with the various composite plies oriented at the desired angles.

Although the described method of forming the tubes is the preferred method, other methods could also be used, such as utilizing a wet lay-up, where fibers are impregnated with resin by hand and then rolled up or by resin transfer molding, wherein dry fibers are packed into a mold, the mold is closed, and resin is pumped or drawn by vacuum into the mold to impregnate the fibers.

Next, a plurality of holes 32 are formed through opposing walls the tube, perpendicular to the axis of the tube. Holes 32 may be stamped through the walls, or, preferably, a tool is used to separate the carbon fibers from one another, without cutting the fibers, to form holes 32. Holes 32, at this stage, need not have the final desired shape.

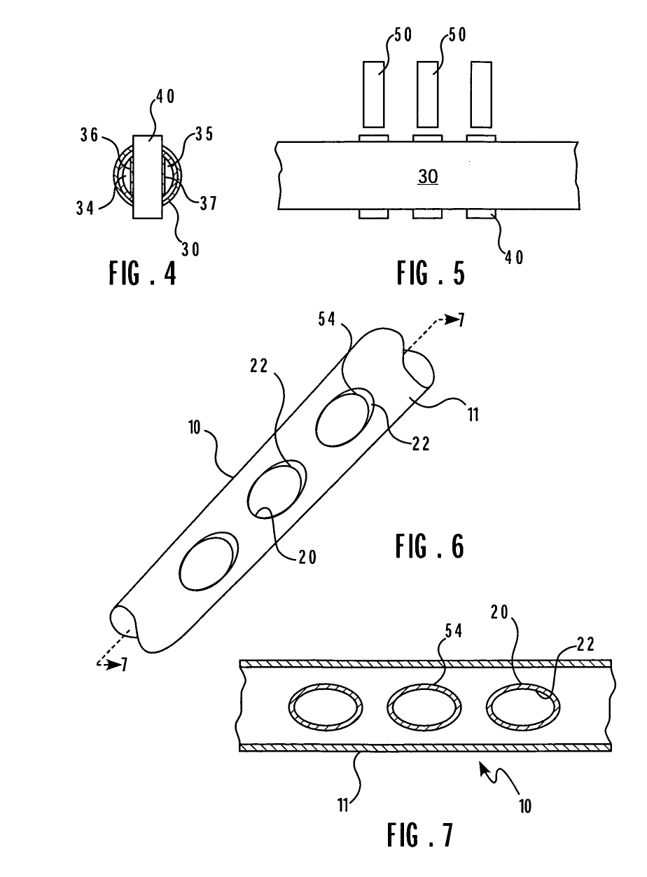

Next, a pair of inflatable bladders 34, 35, preferably made of nylon, is inserted through tube 30 such that their facing walls 36, 37 are aligned with holes 32. Referring to FIGS. 3-5, after bladders 34, 35 have been inserted, a hollow, tubular plug 40 is inserted through each of the holes 32, between the facing walls 36, 37 of the bladders. Thus, as shown in FIG. 4, the plugs 40 separate the two bladders at the points where they are inserted, but otherwise allow the facing walls 36, 37 of bladders 34, 35 to contact each other.

The ends of plugs 40 preferably extend beyond the outer surfaces of the prepreg tube 30, as shown in FIGS. 4-5. Plugs 40 are preferably tubes composed of prepreg material. However, if desired, plugs 40 may be made of other materials such as metal or plastic. Finally, as shown in FIG. 5, if plugs 40 are formed of prepreg material, a mold pin 50 is inserted through each plug 40 to form the internal geometry of the ports and to prevent plugs 40 from deforming during the curing process. This may occur prior to mold packing, or during the mold packing process.

Tube 30 is then packed into a mold (not shown) which forms the shape of the outer surface of the fishing rod. If the mold and tube are longer than the final desired dimension of the fishing rod, a final cut to length operation can be performed on rod 10 after molding.

Air fittings are then attached to the bladders 34, 35. The mold is then closed over tube 30 and placed in a heated platen press. For epoxy resins, the temperature is typically around 350° F. While the mold is being heated, tube 30 is internally pressurized by inflating bladders 34, 35, which compresses the prepreg material and forces tube 30 to assume the shape of the mold. At the same time, the heat cures the epoxy resin. The bladders also compress peripheral walls 22 of the plugs 40, so that the inwardly facing surface of each plug 40 conforms to the shape of mold pin 50 (which, in the preferred embodiment, is oval). At the same time, the heat and pressure cause the ends of plugs 40 to bond to the wall of the prepreg tube 30.

Once cured, the mold is opened in the reverse sequence of packing. Mold pins 50 are typically removed first, followed by the top portion of the mold. Particular attention is needed if removing the top portion with mold pins 50 intact to ensure that this is done in a linear fashion. Once mold pins 50 have been removed from rod 10, the rod can be removed from the bottom portion of the mold.

The above mentioned process describes using internal bladder pressurization for the entire length of the rod. This tends to be slightly more cumbersome than the traditional method of producing a composite fishing rod, which is to roll the prepreg material over a metal mandrel followed by wrapping an external polymeric shrink wrap to consolidate the laminate upon the application of heat.

In an alternative embodiment, it may be desirable to first mold a portion of the rod using the traditional method, for example the portion of the rod which includes the tip. This portion would then be placed in another mold where the bladder molded portion forming the ports would be fused to it.

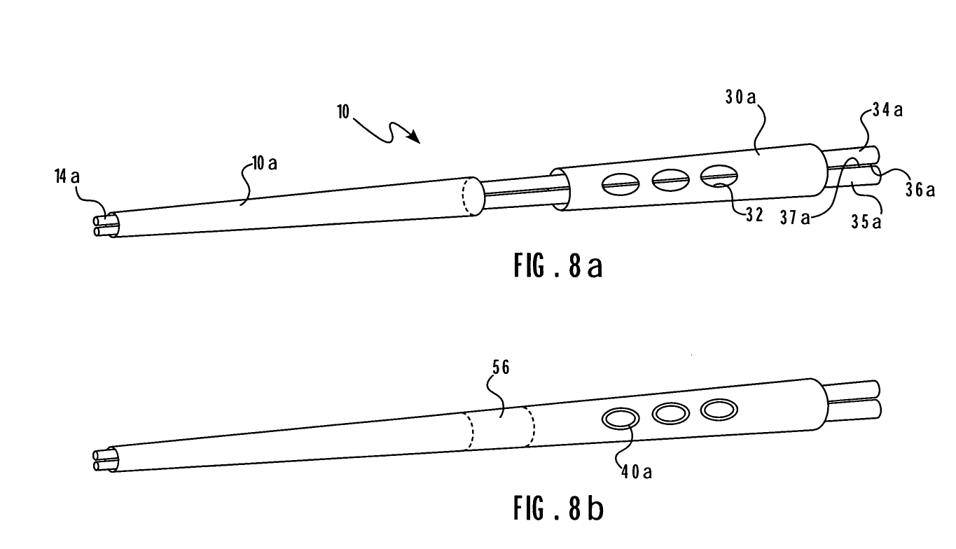

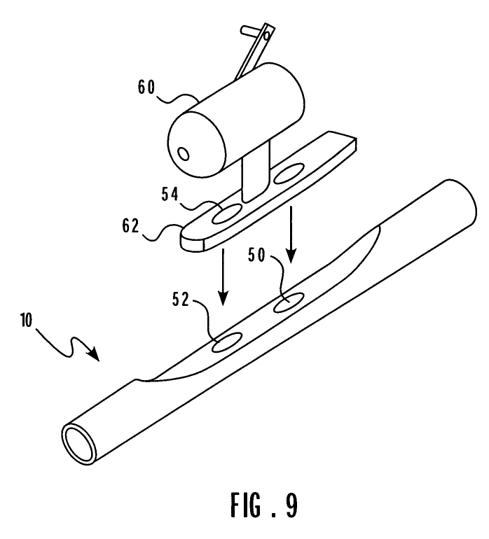

This alternative process is illustrated in FIGS. 8a-8b. The process is identical to that just described, except that rod 10 may be comprised of pre-formed portion 10a which has been previously molded using a traditional method, or which may be composed of an alternate material and has been formed using a process particular to that material. Bladders 34a, 35a may extend through pre-formed portion 10a, if possible, but may also extend only through prepreg portion 30a.

Pre-formed portion 10a is connected to the prepreg portion 30a by means of an overlap joint 56. This is to ensure a strong interface between the two portions. Other joining means may be considered. While the mold is being heated, prepreg tube 30a is internally pressurized, which compresses the prepreg material and forces tube 30a to assume the shape of the mold as well as to bond to pre-formed portion 10a.

As shown in FIGS. 6-7, after molding, the rod 10 is formed of a, primary, hollow, cured tube 11, with a plurality of ports 20 extending through tube 11. The ends of the port walls 54 are bonded to the portions of tube 11 surrounding ports 20, and the inwardly facing surfaces 22 of ports 20 extend completely through tube 11.

The composite material used is preferably carbon fiber reinforced epoxy providing the desired reinforcement at the lightest possible weight. Other fibers may be used, such as fiberglass, aramid, boron and others. Likewise, other thermoset resins may be used such as polyester and vinyl ester. Thermoplastic resins may also be used such as nylon, ABS, PBT and others.

In an alternate embodiment of the invention, ports 20 may be orientated in different directions. For example, alternative ports 20 may be oriented at 90 degrees with respect to each other. Any such arrangement of ports is contemplated to be with the scope of this invention. In such embodiments the manufacturing process is somewhat more complicated and may require the use of multiple bladders instead of two bladders. For example, if it is desired that the ports be oriented at 90 degrees with respect to each other, four bladders will be required, with the interface of the bladders forming a cross shape, where one leg of the cross supports tubular inserts 40 in one direction and the other leg of the cross supports tubular inserts 40 in the orthogonal direction. This embodiment will have the advantage of providing the strength improvements regardless of how the rod is cast, i.e., utilizing an overhead cast versus a horizontal cast, or any casting angle in between. In addition, it is understood that the size, shape and placement of the holes can vary depending upon the desired performance of the rod.

In yet another embodiment of the invention the body of rod 10 may not necessarily be the circular in cross sectional shape but, instead, may be elliptical or any other desired shape, including shapes having straight edges and non-symmetrical shapes, such as polygons and teardrops. The cross-sectional shape of rod 10 is determined by the size and shape of the mold which is used to form the outside surface of rod 10 and by the shape of the bladders used to inflate the rod from within.

In yet another embodiment, ports 20 may be grouped in groups running along the lengths of the rod and need not appear as a sequential grouping all in one portion of the rod.

The size and spacing of the ports can affect rod stiffness in a desirable way. These ports can direct the flex point of the rod toward the lower portion of the rod if desired. An additional benefit of the ports in the rod is that they improve the durability and strength of the rod. This is because they act as arches to distribute the stress placed on the rod during flexing in a very efficient manner. In addition, the cylindrical internal reinforcements formed by the walls of the ports resist compressive loads which tend to buckle the thin walls of the rod tube.

In some embodiments, it may be desirable that the rod have uniform longitudinal or torsional stiffness. In such cases it may be possible to make the rod more stiff at various localized places to compensate for a lack of stiffness that may be caused by a variety of factors. The rod can be made more stiff by adding one or more ridges on the external surface of the rod. For example, the placement of the ports in the rod will tend to decrease the rod stiffness in the areas defining the ports. The stiffness in these areas can be increased by defining ridges in the vicinity of the ports. Such ridges can be longitudinally or circumferentially disposed, and can be of limited length or can run the entire length of the rod. Additionally, the cross-sectional shape of the rod can also affect stiffness, particularly when such cross-sectional shapes define corners, such as with a polygonal or teardrop cross sectional shape. Note that if uniform stiffness is not desired, ridges may be added to increase the stiffness in some areas, while leaving other areas unaltered. Absent any ridges, the stiffness of the rod will be defined by the manner and angle at which the prepreg strips were laid out to form the basic hollow rod, as previously discussed.

In another alternative embodiment, it is also possible to use a metal material for the main rod such as aluminum or steel, and bond composite, metal or plastic cylindrical ports to the aluminum in a similar manner.

In another aspect of the invention, not shown in any figure, a flattened area may be defined on the rod for mounting of the reel. In such a case, the cross sectional shape of the rod in this area would be asymmetrical. Ports may be defined in the rod in this area to facilitate the mounting of the reel to the rod. In cases where the reel is mounted on the rear face of the rod, or on “top” of the rod, another option is for the fishing line to travel from the reel through a port defined in the rod according to this invention, to the opposite side of the rod. This would provide an advantage for reel designs that operate on the top side of the rod, yet position the line and guides on the bottom side of the rod, which is a preferred location because it is more stable. This is not possible with conventional rod designs.

It is to be understood that the invention as described is not intended to be limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of descriptions only and should not be regarded as limiting.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A fishing rod comprising:
a. a tapered, hollow tubular rod;
b. of said rod defining therein one or more pairs of aligned holes extending through opposite portions of said tube; and
c. a peripheral wall extending through each pair of holes;
d. wherein opposite ends of said peripheral walls are bonded to said hollow tube, forming open ports through said rod.

2. The fishing rod of claim 1 wherein said holes and said corresponding peripheral wall are elliptical in shape, forming elliptically-shaped open ports in said rod.

3. The fishing rod of claim 2 wherein said each of said peripheral walls forms a pair of arches, with the long dimension of the ellipsis oriented with the longitudinal axis of said rod said rod.

4. The fishing rod of claim 3 wherein the longitudinal axis of said one or more ports is aligned orthogonal to the longitudinal axis of said rod.

5. The fishing rod of claim 1 wherein said rod defines therein a plurality of open ports, said open ports being radially aligned along said rod with respect to the longitudinal axis of the rod.

6. The fishing rod of claim 1 wherein said rod defines therein a plurality of open ports, wherein the radial angle of the longitudinal axis of said ports about the longitudinal axis of said rod varies.

7. The fishing rod of claim 6 wherein said rod defines therein a first set of open ports wherein the longitudinal axes of each port is disposed at a first angle with respect to the longitudinal axis of said rod, and a second set of open ports wherein the longitudinal axes of each port in said second set are disposed at a second angle with respect to the longitudinal axis of said rod, said second angle being orthogonal to said first angle.

8. The fishing rod of claim 1 wherein said one or more open ports are spaced evenly along the longitudinal axis of said rod.

9. The fishing rod of claim 1 wherein one or more of said open ports are formed into one or more groups.

10. The fishing rod of claim 1 wherein said one or more open ports vary in size.

11. The fishing rod of claim 1 wherein said one or more open ports vary in shape.

12. The fishing rod of claim 1 wherein said one or more open ports vary in size and shape.

13. The fishing rod of claim 1 wherein said rod is composed of a composite material.

14. The fishing rod of claim 13 wherein said composite material used is a fiber reinforced resin.

15. The fishing rod of claim 14 wherein said fibers are selected from a group consisting of carbon, fiberglass, aramid and boron.

16. The fishing rod of claim 15 wherein said resin is selected from a group consisting of epoxy, polyester, vinyl ester, ABS and PBT.

17. The fishing rod of claim 13 wherein said peripheral walls are composed of a material selected from a group consisting of a composite material, plastic and metal.

18. The fishing rod of claim 1 wherein a portion of said rod has been pre-molded.

19. The fishing rod of claim 18 further comprising an overlap joint, said overlap joint forming an interface between said tapered rod and said pre-molded portion.

20. The fishing rod of claim 1 wherein the cross section of said hollow, tubular rod may be any shape.

21. The fishing rod of claim 20 wherein the cross sectional shape of said hollow, tubular rod is selected from a group comprising a circle, an oval, a polygon and a teardrop.

22. The fishing rod of claim 1 wherein a portion of said rod is flattened to all the mounting of a reel thereon.

23. The fishing rod of claim 22 wherein said rod defines one or more open ports disposed on said flattened portion to facilitate the mounting of said reel.

24. The fishing rod of claim 1 wherein said rod defines therein an open port in close proximity to the portion of the rod where a reel would be mounted such as to allow a fishing line to traverse the rod from the rear face of said rod to the front face of said rod.

25. A method of forming a fishing rod comprising the steps of:
a. forming a hollow tube of uncured composite material;
b. forming one of more pairs of aligned holes through opposed walls of said tube;
c. inserting a pair of inflatable bladders through said hollow tube, wherein said bladders are side-by-side, with adjoining walls aligned with said holes;
d. inserting a hollow tubular plug through each pair of aligned holes, said plugs being disposed between said bladders;
e. placing said hollow tube into a closed mold; and
f. heating said mold, while inflating said bladders, such that said hollow tube assumes the shape of the mold and cures, and such that the opposite ends of each of said plugs bonds to said tube.

26. The method of claim 25, wherein said one or plugs are composed of an uncured composite material, further comprising the step of inserting a mold pin through each of said plugs, such that each plug assumes the shape of said mold pin.

27. The method of claim 25 wherein said pairs of aligned holes are formed by punching.

28. The method of claim 25, wherein said pairs of aligned holes are formed by separating fibers in said composite material.

29. The method of claim 25, further comprising the step of joining one or both ends of said hollow tube to one or more pre-formed portions.

30. The method of claim 25 further comprising the step of applying an overlap joint of a composite material between said hollow rod and said one or more pre-formed portions.

31. The method of claim 25 wherein said one or more pairs of holes includes one or more pairs of said holes having longitudinal axes aligned in a first direction and one or more pairs of holes having longitudinal axes aligned in a second direction orthogonal to said first direction, further comprising the step of inserting a second pair of inflatable bladders such that the interface between all four bladders forms a cross shape.
